(19) United States
(12) Patent Application Publication
(10) Pub. No.: US 2022/0300916 A1
(43) Pub. Date: Sep. 22, 2022

(54) INTERNETWORK SWAPPING OF ASSETS

(71) Applicant: R3 Ltd., London (GB)

(72) Inventor: Sotiria Fytraki, London (GB)

(21) Appl. No.: 17/655,749

(22) Filed: Mar. 21, 2022

Related U.S. Application Data
(60) Provisional application No. 63/163,404, filed on Mar. 19, 2021.

(51) Int. Cl. G06Q 20/02; G06Q 20/06; G06Q 20/22; G06Q 20/40

(52) U.S. Cl. CPC G06Q 20/02; G06Q 20/065; G06Q 20/223; G06Q 20/401

(57) ABSTRACT

A system is provided for swapping assets owned by different parties in different networks. The system provides techniques that allow a first party holding a first asset in a first network and a second party holding a second asset in a second network to swap their assets. The result of the swap will be that the first party owns the second asset in the second network and that second party owns the first asset in the first network. The system employs locks and transfer condition and if needed, a resolution strategy to ensure that either the swap occurs or that the parties retain their own assets.

### CROSS-REFERENCE TO RELATED APPLICATION

This application claims priority to U.S. Provisional Patent Application No. 63/163,404 filed Mar. 19, 2021, the content of which is herein incorporated in its entirety.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header, that is, a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. The distributed ledger is a blockchain that includes all the transactions for a bitcoin. The blockchain is stored redundantly at multiple nodes (i.e., computers) of a blockchain network. Each node in the blockchain network will store a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins. Efforts are currently underway to use blockchains to support transactions of any type, such as those relating to the sale of vehicles, sale of financial derivatives, sale of stock, payments on contracts, and so on. Such transactions use tokens to uniquely identify something that can be owned or that can own something. The owner of a token is identified based on the public key of a public/private keypair. When performing a transaction for a token, the owner signs the transaction with its private key (e.g., encrypt a hash of the transaction). The public key can then be used to verify that signature is valid, that is the transaction is signed by the owner.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership and outputs a token identifying the next owner and a token identifying the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using a token that is a hash of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be tokens identifying the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, large amounts of computer resources are required to support such redundant execution of computer code.

Although blockchains can effectively store transactions, the large amount of computer resources, such as storage and computational power, needed to maintain all the replicas of the blockchain can be problematic. To overcome this problem, some systems for storing transactions do not use blockchains, but rather have each party to a transaction maintain its own copy of the transaction. One such system is the Corda system developed by R3, Ltd., which provides a decentralized distributed ledger platform in which each participant in the platform has a node (e.g., computer system) that maintains its portion of the distributed ledger. When parties agree on the terms of a transaction, a party submits the transaction to a notary, which is a trusted node, for notarization. The notary maintains a consumed output database of transaction outputs that have been input into other transactions. When a transaction is received, the notary checks the inputs to the transaction against the consumed output database to ensure that the outputs that the inputs reference have not been spent. If the inputs have not been spent, the notary updates the consumed output database to indicate that the referenced outputs have been spent, notarizes the transaction (e.g., by signing the transaction or a transaction identifier with a private key of the notary), and sends the notarized transaction to the party that submitted the transaction for notarization. When the party receives the notarized transaction, the party stores the notarized transaction and provides the notarized transaction to the counterparties.

A distributed ledger system may support identifying a transaction with a hash derived from the content of the transaction. The hash may be the hash of a root node of a Merkle tree for the content. The Merkle tree contains leaf nodes corresponding to hashes of components of the transaction such as a reference that identifies an output of a prior transaction that is input to the transaction, an attachment, and a command. Each non-leaf node contains a hash of the hashes of its child nodes. The Merkle tree may also be considered to have each component as the leaf node with its parent node corresponding to the hash of the component.

A Merkle tree representation of a transaction allows an entity needing access to that transaction to be provided with only that portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction by generating a hash of the transaction summary and calculating the hashes of the nodes along the path to the root node. If the calculated hash of the root node matches the hash of the transaction, the transaction summary is confirmed as the one used in the transaction. Because only the portion of the Merkle tree relating to components that an entity needs is provided, the entity will not have access to other components. Thus, the confidentiality of the other components is not compromised.

A notary may be a non-validating notary or a validating notary. When a non-validating notary is to notarize a transaction, it simply ensures that the prior output of a prior transaction, that is, the input of the transaction, has not been consumed that is an UXTO. If the prior output has not been consumed, the non-validating notary notarizes the transaction by signing a hash of the transaction. To notarize a transaction, a non-validating notary needs only the identification of the prior output (e.g., the hash of the prior transaction and the index of the output) and the portion of the Merkle tree needed to calculate the hash of the transaction.

A validating notary validates the transaction, which may include ensuring that all prior transactions in a backchain of transactions are valid. A backchain is the collection of each prior transaction of the transaction, each prior transaction of those prior transactions, and so on. To validate a transaction, a validating notary invokes validation code of the smart contract of the transaction. The validation code performs whatever checks are needed to comply with the terms applicable to the transaction. This checking may include retrieving the public key of the owner from the prior transaction (pointed to by the input state of the transaction) and checks the signature of the transaction, ensuring that the prior output of a prior transaction that is input has not been consumed, and checking the validity of each transaction in the backchain of the transactions. If the validation code indicates that the transaction is valid, the validating notary notarizes the transaction and records the output of the prior transaction as consumed.

### BRIEF DESCRIPTION OF THE DRAWINGS

FIG. 1 is a data flow diagram that illustrates the flow of data during an atomic swap of the IAAS system.

FIG. 2 is a flow diagram that illustrates the processing of a node that sends a swap request.

FIG. 3 is a flow diagram that illustrates the processing of a node that receives a swap request.

FIG. 4 is a flow diagram that illustrates the processing of a node that receives information relating to a swap from a node that receives a swap request.

FIG. 5 is a diagram that illustrates the processing of a node that coordinate the notarization of a transaction to transfer an asset as part of a swap.

### DETAILED DESCRIPTION

A method and system are provided for swapping assets owned by different parties in different networks. In some embodiments, an internetwork asset atomic swap (IAAS) system provides techniques that allow a first party holding a first asset in a first network and a second party holding a second asset in a second network to swap their assets. The result of the swap will be that the first party owns the second asset in the second network and that second party owns the first asset in the first network. To swap the assets, both parties have nodes in both networks. The IAAS system helps overcome incompatibility of the networks that prevent a single transaction from transferring an asset from a node in one network to a node in another network. For example, unless the networks have notaries that are synchronized (or share a notary), the notaries will not know which output states of transactions in the other network have been consumed. In such a case, if the first party prepares a transaction to transfer the first asset to the second party and sends it to the second party, the notary of the second network will not know whether the output that is input as the first asset has been consumed. Moreover, the network may have formats for transactions that are incompatible. For example, the networks may employ different public/private keypair formats such as 512 bits versus 1024 bits.

The IAAS system employs a primary resolution strategy and a secondary resolution strategy for handling internetwork swaps. The primary resolution strategy allows the assets to be swapped under circumstances (e.g., network delays) that are considered to be normal. The secondary resolution strategy allows swaps to be completed or ownership reverted under circumstances that are considered to be not normal. The primary resolution strategy helps to minimize the load on a second notary of the second network to complete a swap. The secondary resolution strategy in contrast places additional load on the second notary which is necessary in circumstances that are not normal. A goal of the IAAS system is to minimize the load on the second notary so that the load does not significantly increase compared to networks that do not support internetwork atomic swaps. Another goal is to ensure that either the swap occurs exchanging ownership of the assets or that ownership reverts to the status before the swap was attempted. In other words, a goal is to prevent a party from owning both assets, one party from owning an asset and the other party not owning the other asset, and neither party from owning an asset.

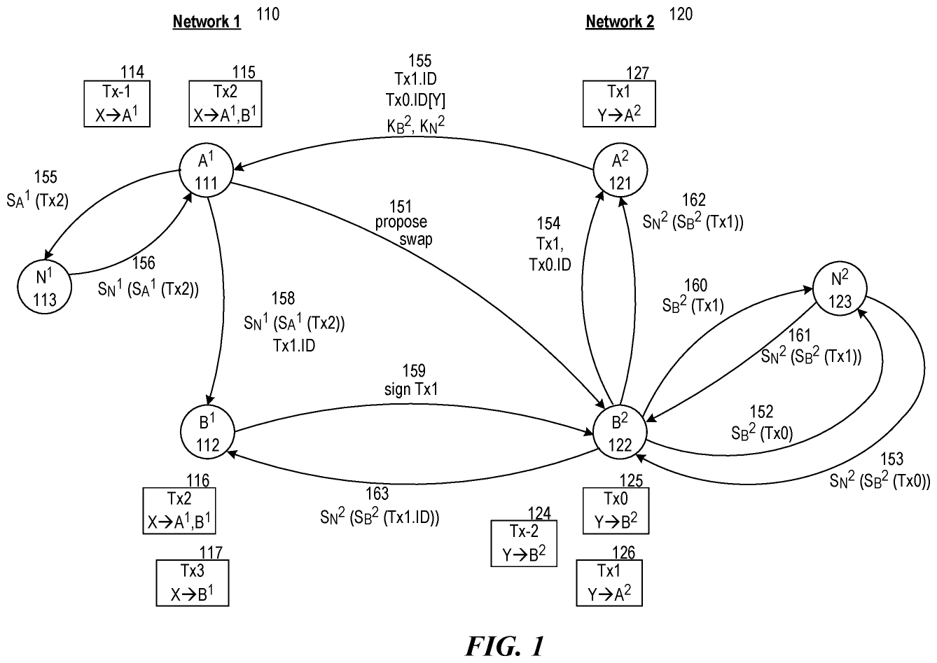

FIG. 1 is a data flow diagram that illustrates the flow of data during an atomic swap of the IAAS system. Network 1 110 includes node A¹ 111 of party A and node B¹ 112 of party B, and network 2 120 includes node A² 121 of party A and node B² 122 of party B. Network 1 includes notary N¹ 113, and network 2 includes notary N² 123. Party A owns asset X in network 1, and party B owns asset Y in network 2. Party A and party B want to swap ownership of assets X and Y. Since asset X can only be held in network 1 and asset Y can only be held in network 2, node A² can hold asset Y for party A, and node B¹ can hold asset X for party B. A node holds an asset by storing a notarized transaction for the asset in its vault. Party A owns asset X as evidence by transaction Tx-1 114 stored in the vault of node A¹, and party B owns asset Y as evidenced by transaction Tx-2 124 stored in the vault of node B². Tx-1 and Tx-2 represent ownership of assets X and asset Y prior to the swap.

Each notary maintains a consumed output data structure with an entry for each output of a transaction in its network that has been consumed. To notarize a transaction, a notary validates a transaction by ensuring that the inputs to the transaction have not been consumed and that the transaction includes the signatures of the parties who own the outputs of transactions corresponding to the inputs. The notary also ensures that a transaction complies with the terms of the input transactions (e.g., implemented via smart contact of the input transactions). If a transaction is valid, the notary signs the transaction with its private key. The notary also adds an entry to the consumed output data structure for each output of a transaction that is consumed by the transaction being notarized. The notary also functions as a timestamp authority. Each entry includes the time the transaction was notarized. The timestamp is used to determine whether a lock has expired (discussed below).

To initiate the swap of asset X and asset Y, node A¹ sends 151 a message to node B² outlining the terms of the swap. If party B agrees to the swap, node B² creates a transaction Tx0 125 that outputs asset Y with a restriction that asset Y can only be transferred to node A² during a lock period (e.g., current time plus a delta period). If the output of Tx0 is not consumed during the lock period, (i.e., not transferred to party A) ownership of asset Y remains with party B. The lock is enforced by a smart contract of Tx0. If not transferred to node A² during the lock period, party B can freely transfer asset Y. Node B² then signs and notarizes 152 and 153 Tx0 and stores Tx0 in its vault. (It is actually a notary who performs the notarization, but the phrase “a node notarizes” should be understood to mean that the node directs or requests the notary to perform the notarization.)

Node B² then generates transaction Tx1 126 which inputs asset Y from Tx0 and transfers asset Y to node A². Node B², however, does not yet sign Tx1. Node B² then sends 154 unsigned Tx1 and the transaction identifier Tx0.ID of Tx0 to node A². The transaction identifier of a transaction may be the hash of a hash tree (e.g., Merkle tree) representation of the transaction. Node A² verifies that Tx1 transfers asset Y to node A² per the terms of the swap. As part of the verification, node A² verifies the backchain of transactions for asset Y and verifies the lock that is output by Tx0 and input by Tx1. Node A² then sends 155 to node A¹ verification of the proposed swap that includes Tx1.ID, the public key of node B² (K_{B}²), and the public key of notary N² (K_{N}²), and a reference to the input asset Y which is the output of asset Y in Tx0 (Tx0.ID[Y]). Tx0.ID[Y] id needed for the secondary resolution strategy.

Upon receiving the verification, node A¹ generates and notarizes 155 and 156 transaction Tx2 115 that inputs asset X and transfers asset X to node A¹ or node B¹ but specifies a transfer condition for transferring to node A¹ or B¹ and a possibly a lock period. The condition specifies that asset X can only be transferred to node B¹ if evidence is presented that Tx1 has been notarized, that is, asset Y has been transferred to node A². The lock period specified that during the lock period, asset 1 can only transferred to node B¹. The evidence that Tx1 has been notarized is Tx1.ID that has been signed by node B² and notarized by notary N² and can be confirmed using K_{B}² and K_{N}² that were provided by node A¹. When node B² provides this evidence to node B¹ and it is within the lock period of T the primary resolution strategy is employed to complete the swap. With this evidence, node B¹ can generate and notarize a transaction that transfers ownership of asset X to node B¹. If node B¹ does not receive this evidence within the lock period of Tx2, the secondary resolution strategy is employed to either complete the swap or terminate the swap so that party A maintains ownership of asset X and party B maintains ownership of asset Y. Node A¹ and node B¹ can use Tx0.ID[Y] to query notary N² to determine whether asset Y was transferred to party A within the lock period of Tx0 based on a timestamp provided by N². If transferred, B¹ can use this evidence to claim asset 1 via Tx2. If not transferred, A¹ can use this evidence to reclaim asset 1 via Tx2. The lock period of Tx2 delays the start of the second resolution strategy to allow time for node B1 to receive evidence that Tx1 was notarized which helps to reduce computational burden placed on notary N².

Node A¹ then sends 158 notarized Tx2 and Tx1.ID to node B¹. Upon receiving notarized Tx2, node B¹ verifies the terms of Tx2, that is, asset X can be transferred to node B¹ given the proper evidence. Upon verification, node B¹ sends 159 to node B² confirmation of Tx2 indicating that Tx1 can be signed. Upon receiving the confirmation, node B² signs and notarizes 160 and 161 Tx1 and then sends 162 Tx1 to node A² to affect the transfer of asset Y to node A² of party A. Node B² then sends 163 notarized Tx1.ID to node B¹. To complete the swap using the primary resolution strategy (during the lock period of Tx2), node B¹ generates and notarizes a transaction Tx3 that inputs asset X from Tx2 and notarized Tx1.ID and transfers asset X to node B¹.

The notarizing of Tx3 completes the swap, and party A owns asset Y as evidenced by notarized Tx1 stored in the vault of node A2, and party B owns asset X as evidenced by notarized Tx1 stored in the vault of node B1.

If the swap is not completed within the lock period of Tx2, the secondary resolution strategy is employed. For example, the swap may not be completed if the lock period of Tx0 expires.

When the secondary resolution strategy is employed, node A¹ and node B¹ can contact N² to determine the current status of asset Y. The status of asset Y output by Tx0 after the lock period of Tx0 expires may be (1) consumed within the lock period of Tx0, (2) consumed but not within the lock period Tx0, or (3) not consumed. Since node A¹ and node B¹ were sent Tx0.ID[Y] (155 and 158, respectively), they can each query N² to determine the status of asset Y that is output by Tx0. Upon receiving a query, N² (which is a timestamp authority) checks its consumed output data structure to determine whether Tx0.ID[Y] has been consumed and, if so, when. N² then responds to the query with the status and, if consumed, the timestamp. Statuses (2) and (3) can only be determined after the lock of Tx0 has expired.

Status (1) of Asset Y: If the response to a query by node B¹ indicates that of TX0.ID[Y] was consumed within the lock period of Tx0, asset Y could only have been transferred to node A² per the lock of Tx0—although notarized Tx1 may not have been delivered to node A². Once node B¹ receives the evidence from N², node B¹ can notarize Tx3 to complete the swap. However, asset Y could have been transferred to node A² via Tx1 or Tx1′. Tx1′ may be identical to Tx1 except its transaction identifier Tx1′.ID is different from Tx1.ID. However, if asset X was consumed by Tx1′, the swap cannot be completed because node B¹ will not receive evidence that Tx1 was notarized by N². In such a case, node A² will own asset Y, but ownership of asset X reverts to node A¹ because of the condition of Tx2 and node A¹ can provided the evidence received from N² that asset Y was not transferred via Tx1. Node B², however, is in control of preventing such an undesirable scenario (from its perspective) from occurring by not notarizing Tx1′.

Statuses (2) and (3) of Asset Y: If the response from N² to the query by node B¹ indicates that TX0.ID[Y] was consumed but not within the lock period of Tx0 or has not yet been consumed, asset Y could only have been transferred back to node B² per the lock of Tx0. In such a case, node B¹ cannot notarize Tx3. If node A¹ also queries N², the response will also indicate that asset Y was transferred back to node B². Using this response as evidence, node A¹ can transfer asset X output by Tx2 to itself to cancel the swap after the lock of Tx2 has expired.

Another scenario that can occur is that node B² may refuse to send the signed and notarized Tx1 to node A². Node A², however, can detect this scenario and report to the problem to the rest of the network. Because node A² received 154 a reference to Tx1, node A² can query the notary N² to determine the status of Tx1.

The time period of the lock for Tx0 and the time period of the lock for Tx2 should be set to allow sufficient time for the processing of the nodes to complete given anticipated network and processing delays under normal load. So, the time period is provisioned for the successful completion under normal load. If for some reason the delays are longer than normal, the IAAS system employs the second resolution strategy to either complete the swap or effect cancellation of the swap. For example, the time period of the lock for Tx0 may start with the time Tx0 is notarized and end some delta time later. The delta time for Tx0 starting when Tx0 is notarized should be sufficient to allow for Tx1 to be notarized within that delta time under normal load which the primary resolution strategy requires. Similarly, a delta time for Tx2 starting when Tx2 is notarized should be sufficient to allow for Tx3 to be notarized within that delta time which the primary resolution strategy also requires.

The computing systems (e.g., nodes) on which IAAS system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and second memory (e.g., DVD) and other storage. The computer-readable storage media may have recorded on it or may be encoded with computer-executable instructions or logic that implements the IAAS system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys. The signing of a transaction may be performed using a private key of a public/private keypair, and the verifying of the transaction may be performed using the public key.

The IAAS system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the IAAS system may be implemented in hardware using, for example, an application-specific integrated circuit (“ASIC”) or field programmable gate array (“FPGA”).

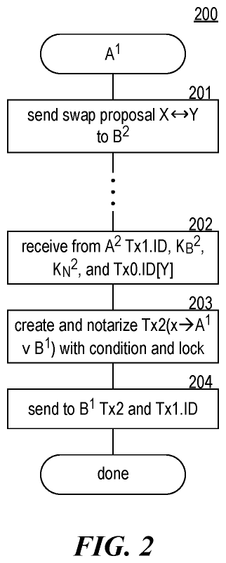

FIGS. 2-5 are flow diagrams that illustrate the processing of components of the IAAS system in embodiments. Although the execution of each component is described as being performed by a node different nodes can execute parts of the processing. For example, node A¹ can perform the processing of block 201 and node A^{1.1} can perform the processing of block 202-204 of FIG. 2. Also, although the assets are described as being owned by a party involved a swap, the parties may be acting on behalf of the owner of the asset and the parties may be consider to be more generally associated with an asset.

FIG. 2 is a flow diagram that illustrates the processing of a node that sends a swap request. A component 200 of node A1 initiates the swaps. In block 201, the component sends to node B2 a swap proposal to swap asset X and asset Y. In block 202, the component receives from node A2 Tx1.ID, Kb2, KN2, and Tx0.ID[Y]. In block 203, the component creates and notarizes Tx2. In block 204, the component sends to node B1 Tx2 and Tx1.ID and then completes. Although not illustrated the component may participate in a secondary resolution to reclaim asset X.

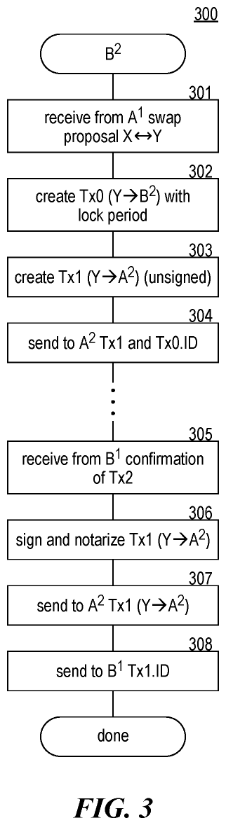

FIG. 3 is a flow diagram that illustrates the processing of a node that receives a swap request. A component 300 of node B2 creates and notarizes Tx0 and Tx1. In block 301, the component receives from node A1 a swap request to swap asset X and asset Y. In block 302, the component creates and notarizes Tx0. In block 303, the component creates Tx1 but does not sign or notarize Tx1. In block 304, the component sends to node A2 Tx1 and Tx0.ID. In block 305, the component receives from node B1 confirmation of Tx2. In block 306, the component signs and notarizes Tx1. In block 307, the component sends to A2 Tx1. In block 308, the component sends to B1 Tx1.ID and then completes.

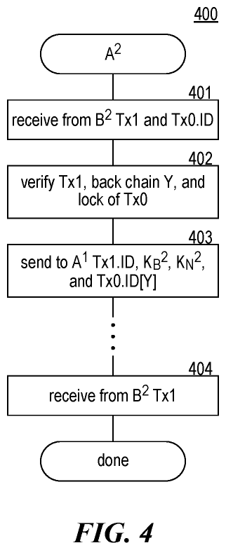

FIG. 4 is a flow diagram that illustrates the processing of a node that receives information relating to a swap from a node that receives a swap request. A component 400 of node A2 sends to node A1 the received information. In block 401, the component receives from node B2 Tx1 and Tx0.ID. In block 402, the component verifies the backchain of prior transaction involving asset Y to ensure that node B2 has sufficient rights to transfer asset Y and verify Tx0 to ensure in correctly locked asset Y. In block 403, the component sends to node A1 Tx1.ID, Kb2, KN2, and Tx0.ID[Y]. In block 404, the component receives from node B2 notarized Tx1 and then completes. Although not illustrated the component may report a problem if Tx1 is not received but asset X is transferred to B1.

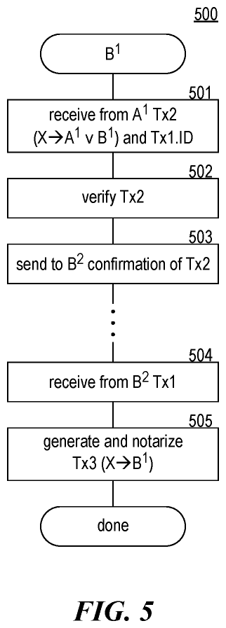

FIG. 5 is a diagram that illustrates the processing of a node that coordinate the notarization of a transaction to transfer an asset as part of a swap. A component 500 receives Tx2 and creates and notarizes Tx3 to transfer asset X to node B1 to complete the swap. In block 501, the component receives from note A1 Tx2 and Tx1.ID. In block 502, the component verifies Tx2 to ensure the conditions of transfer of asset X are correct. In block 503, the component sends to B2 confirmation of verification of Tx2. In block 504, the component receives from B2 Tx1. In block 505, the component generates and notarizes Tx3 using Tx1 as evidence that the condition of Tx2 is satisfied and then completes. Although not illustrated the component may participate in a secondary resolution to claim asset X.

The following paragraphs describe various embodiments of aspects of the IAAS system. An implementation of the IAAS system may employ any combination of the embodiments. The processing described below may be performed by a computing device with a processor that executes computer-executable instructions stored on a computer-readable storage medium that implements the IAAs system.

In some embodiments, a method performed by one or more computing systems is provided for performing an internetwork swap of a first asset of a first party held in a first network and a second asset of a second party held in a second network. The method creates and notarizes a first transaction in the first network that transfers the first asset to the first party with a first lock indicating that the first asset can only be transferred to the second party during a first lock period. The method creates a second transaction in the first network that transfers the first asset as output by the first transaction to the second party. The method, after creating the first transaction and the second transaction, creates and notarizes a third transaction in the second network that transfers the second asset to the first party or to the second party based on a transfer condition specifying that the second asset can be transferred to the first party when the second transaction has been notarized. The method, after creating and requesting notarization of the third transaction, notarizes the second transaction. The method, after notarization of the second transaction, notarizes a fourth transaction in the second network that transfers the second asset output by the third transaction to the first party. In some embodiments, the first party has first party nodes in the first network and in the second network and the second party has second party nodes in the first network and the second network. In some embodiments, the creating and notarizing of the first transaction and the second transaction are performed by a first party node, the creating and notarizing of the third transaction are performed by a second party node, and the notarizing of the fourth transaction is performed by a first party node.

In some embodiments, a method performed by a first node of a first in a first network is provided for participating in an exchange of a first asset in the first network for a second asset in a second network. The first asset is associated with a first party, and the second asset is associated with a second party. The method creates and notarizes a first transaction that transfers the first asset to the first party with a lock indicating that the first asset can only be transferred to the second party during a lock period. The method creates a second transaction that transfers the first asset as output by the first transaction to the second party. The method sends to a second node of the second party in the first network an indication of first transaction and an indication of the second transaction. The method receives from a third node of the first party in the second network an indication that the second transaction can be notarized. The method requests notarization of the second transaction. The method sends the notarized second transaction to the third node. In some embodiments, the indication of the first transaction is the transaction, and the indication of the second transaction is an identifier of the second transaction.

In some embodiments, a method performed by a first node in a first network is provided for participating in an exchange of a first asset in the first network for a second asset in a second network. The first asset is associated with a second party, and the second asset is associated with a first party. The method receives from a second node in the first network a first transaction that includes a transfer condition under which the first asset can be transferred to the first party or to the second party and an indication of a second transaction in the second network that transfers the second asset to the second party. The transfer condition specifies that the first asset can be transferred to the first party only when the second transaction has been notarized. The method, upon verification of the second transaction, sends to a third node in the second network a notification that the second transaction can be notarized. The method, upon receiving from the third node a notification that the second transaction has been notarized, notarizes of a third transaction that transfers the first asset as output by the first transaction to the first party based on the transfer condition of the first transaction being satisfied. In some embodiments, the notification that the second transaction has been notarized includes the notarized second transaction for determining whether the transfer condition of the first transaction is satisfied. In some embodiments, the determining is based on using a public key of a notary of the second network to confirm the notarized transaction was signed by the notary and using a public key of the first party for the second network to confirm that the notarized transaction was signed by the second party.

In some embodiments, a method performed by one or more computing systems associated with a first party is provided for performing a swap of a first asset of the first party held in a first network and a second asset of a second party held in a second network. The method requests notarization of a first transaction that outputs the first asset and specifies that the first asset can only be transferred to the second party during a lock period. The method creates a second transaction in the first network to transfer the first asset as output by the first transaction to the second party. The method receives a notarized third transaction that transfers the second asset to the first party or to the second party based on a transfer condition specifying that the second asset can be transferred to the first party when the second transaction has been notarized. The method, after verifying the third transaction, notarizes the second transaction. The method, after notarization of the second transaction, notarizes a fourth transaction that transfers the second asset output by the third transaction to the first party. In some embodiments, the performing of the swap ensures either the swap completes or that first asset remains with the first party and the second asset remains with the second party.

In some embodiments, one or more computing systems are provided for performing an atomic swap of a first asset of the first party held in a first network and a second asset of a second party held in a second network. The one or more computing systems include one or more computer-readable storage mediums storing computer-executable instructions for controlling the one or more computing systems and one or more processors for executing the computer-executable instructions stored in the one or more computer-readable storage mediums. The instructions request notarization of a first transaction that outputs the first asset and specifies that the first asset can only be transferred to the second party during a lock period. The instructions create a second transaction to transfer the first asset as output by the first transaction to the second party. The instructions receive a notarized third transaction that transfers the second asset to the first party or to the second party based on a transfer condition that specifies the second asset can only be transferred to the first party only after the second transaction has been notarized. The instructions direct notarization of the second transaction. The instructions request notarization of a fourth transaction that transfers the second asset output by the third transaction to the first party. In some embodiments, the swap ensures either the swap completes or that first asset remains with the first party and the second asset remains with the second party.

In some embodiments, one or more computing systems associated with a first party are provided for performing a swap of a first asset of the first party held in a first network and a second asset of a second party held in a second network. The one or more computing system include one or more computer-readable storage mediums storing computer-executable instructions for controlling the one or more computing systems and one or more processors for executing the computer-executable instructions stored in the one or more computer-readable storage mediums. The instructions request notarization of a first transaction that outputs the first asset and specifies that the first asset can only be transferred to the second party during a first lock period. The instructions create a second transaction in the first network to transfer the first asset as output by the first transaction to the second party. The instructions receive a notarized third transaction that transfers the second asset to the first party or to the second party based on a transfer condition specifying that the second asset can be transferred to the first party based on evidence that the second transaction has been notarized and to the second party only after a second lock period based on evidence that the second transaction was not notarized. The instructions direct notarization of the second transaction. The instructions, after notarization of the second transaction, request notarization of a fourth transaction that transfers the second asset output by the third transaction to the first party. The instructions request a notary of the first network to provide evidence of notarization of the second transaction wherein the notarization of the fourth transaction is based on the evidence.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by one or more computing systems for performing an internetwork swap of a first asset of a first party held in a first network and a second asset of a second party held in a second network, the method comprising:
creating and requesting notarizing a first transaction in the first network that transfers the first asset to the first party with a first lock indicating that the first asset can only be transferred to the second party during a first lock period;
creating a second transaction in the first network that transfers the first asset as output by the first transaction to the second party;
after creating the first transaction and the second transaction, creating and requesting notarization of a third transaction in the second network that transfers the second asset to the first party or to the second party based on a transfer condition specifying that the second asset can be transferred to the first party when the second transaction has been notarized;
after creating and requesting notarization of the third transaction, directing notarization of the second transaction; and
after notarization of the second transaction, requesting notarization of a fourth transaction in the second network that transfers the second asset output by the third transaction to the first party.

2. The method of claim 1 wherein the first party has first party nodes in the first network and in the second network and the second party has second party nodes in the first network and the second network.

3. The method of claim 2 wherein the creating and the requesting notarization of the first transaction and the second transaction are performed by a first party node, the creating and requesting notarization of the third transaction are performed by a second party node, and the requesting notarization of the fourth transaction is performed by a first party node.

4. A method performed by a first node of a first in a first network for participating in an exchange of a first asset in the first network for a second asset in a second network, the first asset associated with a first party and the second asset associated with a second party, the method comprising:
creating and requesting notarization of a first transaction that transfers the first asset to the first party with a lock indicating that the first asset can only be transferred to the second party during a lock period;
creating a second transaction that transfers the first asset as output by the first transaction to the second party;
sending to a second node of the second party in the first network an indication of first transaction and an indication of the second transaction;
receiving from a third node of the first party in the second network an indication that the second transaction can be notarized;
requesting notarization of the second transaction; and
sending the notarized second transaction to the third node.

5. The method of claim 4 wherein the indication of the first transaction is the transaction and the indication of the second transaction is an identifier of the second transaction.

6. A method performed by a first node in a first network for participating in an exchange of a first asset in the first network for a second asset in a second network, the first asset associated with a second party and the second asset associated with a first party, the method comprising:
receiving from a second node in the first network, a first transaction that includes a transfer condition under which the first asset can be transferred to the first party or to the second party and an indication of a second transaction in the second network that transfers the second asset to the second party, the transfer condition specifying that the first asset can be transferred to the first party only when the second transaction has been notarized;
upon verification of the second transaction, sending to a third node in the second network a notification that the second transaction can be notarized; and
upon receiving from the third node a notification that the second transaction has been notarized, requesting notarization of a third transaction that transfers the first asset as output by the first transaction to the first party based on the transfer condition of the first transaction being satisfied.

7. The method of claim 6 wherein the notification that the second transaction has been notarized includes the notarized second transaction for determining whether the transfer condition of the first transaction is satisfied.

8. The method of claim 7 wherein the determining is based on using a public key of a notary of the second network to confirm the notarized transaction was signed by the notary and using a public key of the first party for the second network to confirm that the notarized transaction was signed by the second party.

9. A method performed by one or more computing systems associated with a first party for performing a swap of a first asset of the first party held in a first network and a second asset of a second party held in a second network, the method comprising:
requesting notarization of a first transaction that outputs the first asset and specifies that the first asset can only be transferred to the second party during a lock period;
creating a second transaction in the first network to transfer the first asset as output by the first transaction to the second party;
receiving a notarized third transaction that transfers the second asset to the first party or to the second party based on a transfer condition specifying that the second asset can be transferred to the first party when the second transaction has been notarized;
after verifying the third transaction, directing notarization of the second transaction;
after notarization of the second transaction, requesting notarization of a fourth transaction that transfers the second asset output by the third transaction to the first party.

10. The method of claim 9 wherein the performing of the swap ensures either the swap completes or that first asset remains with the first party and the second asset remains with the second party.

11. One or more computing systems for performing an atomic swap of a first asset of the first party held in a first network and a second asset of a second party held in a second network, the one or more computing systems comprising:
one or more computer-readable storage mediums storing computer-executable instructions for controlling the one or more computing systems to:
request notarization of a first transaction that outputs the first asset and specifies that the first asset can only be transferred to the second party during a lock period;
create a second transaction to transfer the first asset as output by the first transaction to the second party; and
receive a notarized third transaction that transfers the second asset to the first party or to the second party based on a transfer condition that specifies the second asset can only be transferred to the first party only after the second transaction has been notarized;
direct notarization of the second transaction; and
request notarization of a fourth transaction that transfers the second asset output by the third transaction to the first party and
one or more processors for executing the computer-executable instructions stored in the one or more computer-readable storage mediums.

12. The one or more computing systems of claim 11 wherein the swap ensures either the swap completes or that first asset remains with the first party and the second asset remains with the second party.

13. One or more computing systems associated with a first party for performing a swap of a first asset of the first party held in a first network and a second asset of a second party held in a second network, the one or more computing system comprising:
one or more computer-readable storage mediums storing computer-executable instructions for controlling the one or more computing systems to:
request notarization of a first transaction that outputs the first asset and specifies that the first asset can only be transferred to the second party during a first lock period;
create a second transaction in the first network to transfer the first asset as output by the first transaction to the second party;
receive a notarized third transaction that transfers the second asset to the first party or to the second party based on a transfer condition specifying that the second asset can be transferred to the first party based on evidence that the second transaction has been notarized and to the second party only after a second lock period based on evidence that the second transaction was not notarized;
direct notarization of the second transaction; and
after notarization of the second transaction, request notarization of a fourth transaction that transfers the second asset output by the third transaction to the first party; and
one or more processors for executing the computer-executable instructions stored in the one or more computer-readable storage mediums.

14. The one or more computing systems of claim 13 wherein the instructions further include instructions to request a notary of the first network to provide evidence of notarization of the second transaction wherein the notarization of the fourth transaction is based on the evidence.
